(19) United States
(12) Patent Application Publication
(10) Pub. No.: US 2005/0260907 A1
(43) Pub. Date: Nov. 24, 2005

(54) Laminate for counteraction an ethylene response in plants, method of making, or using the same

(76) Inventors: William T. H. Chang, Taipei (TW); James H. Y. Chen, Taipei (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/847,450

(22) Filed: May 18, 2004

(51) Int. Cl. B32B 5/02; B32B 27/04; B32B 27/12; B32B 31/30; B32B 17/02; B32B 1/00; B32B 27/36

(52) U.S. Cl. 442/62; 442/123; 442/172

(57) ABSTRACT

Disclosed is a non-woven fabric laminate for inhibiting an ethylene response in a plant, comprising at least one layer of a thermoplastic composition comprising an agent for blocking an ethylene binding site in plants and a thermoplastic polymer or copolymer, and at least one layer of a non-woven fabric. A method of making the non-woven fabric laminate and a method for inhibiting an ethylene response in plants are also disclosed therein. Further disclosed is an aluminum foil laminate or a corrugated paper carton laminate for inhibiting an ethylene response in a plant, comprising at least one layer of a thermoplastic composition comprising an agent for blocking an ethylene binding site in plants and a thermoplastic polymer or copolymer, and at least one layer of an aluminum foil or a corrugated paper carton.

### FIELD OF THE INVENTION

The present invention relates to a novel laminate for regulating plant physiology, in particular counteracting ethylene response, containing a blocking agent, which has ethylene binding site inhibition activity to plants, specifically a novel non-woven fabric laminate, a method of making the non-woven fabric laminate, and a method of inhibiting various ethylene responses by applying the laminate of the present invention.

### BACKGROUND OF THE INVENTION

It is well known that ethylene can induce leaf yellowing of vegetables, the ripening of fruits and the senescence of flowers. The commercial valve of fresh produce is usually reduced by the excessive amount of ethylene gas, which is associated with early ripening of plants. Extensive studies have been devoted to controlling ethylene gas for post-harvest preservation of fresh produce.

For example, U.S. Pat. No. 5,518,988 discloses the use of cyclopropene and its derivatives, such as 1-methylcyclopropene (1-MCP), as effective blocking agents for ethylene binding site. However, 1-MCP is typically unstable for its high chemical activity. U.S. Pat. No. 6,017,849 discloses a method of encapsulating 1-MCP gas into a carrier. The carrier such as alpha-cyclodextrin serves to stabilize the reactivity and instability of cyclopropene gas, thereby providing a convenient and safe means of storing, transporting and applying or delivering the gas to plants.

Commercial 1-MCP powder products are usually added to water or a buffer solution to release the 1-MCP gas into the atmosphere where agriculture products to be treated are stored. Effective concentrations of 1-MCP vary with respect to time, temperature and manner of application. Typical treatment concentrations are 0.1 to 1.0 ppm (vol/vol) in the atmosphere surrounding the agricultural products.

The powder products are much more convenient to use than the products in gas form, but are by no means user-friendly. They still have disadvantages related to powder handling in the field. PCT Publication No. WO02/24171 A1 discloses an effervescent tablet formulation to alleviate the disadvantages of mixing associated with the application of the powder form. The tablet form product is easier to enumerate, and with a controlled-release mechanism that is not possible with powder form. Such tablets are more user-friendly for non-technical customers, florists and wholesalers than powder form.

However, the tablets, similar to powder, are still limited in their application since they usually require air circulation to ensure uniform distribution of the effective agent, which is sometimes not available in field condition. Uneven concentration of 1-MCP in the atmosphere would create uneven ripening-response, thus reducing the commercial application effectiveness. There is a need to resolve this problem. Therefore, the present invention provides a new laminate based on a totally new concept, allowing uniform delivery of 1-MCP to the plant material, and even more user-friendly than the effervescent tablets. The present invention offers significant improvements for post harvest preservation technology that has not been possible until now.

### SUMMARY OF THE INVENTION

It is therefore an object of the invention to provide a non-woven fabric laminate comprising at least one layer of a thermoplastic composition, comprising an agent for blocking ethylene binding site in plants and a thermoplastic polymer or copolymer, and at least one layer of a non-woven fabric.

It is another object of the invention to provide a method of making the non-woven fabric laminate of the present invention.

It is a further object of the invention to provide a method for inhibiting an ethylene response in a plant.

It is also an object of the invention to provide an aluminum foil laminate or a corrugated paper carton laminate for inhibiting an ethylene response in a plant, comprising at least one layer of a thermoplastic composition comprising an agent for blocking ethylene binding site in plants and a thermoplastic polymer or copolymer, and at least one layer of an aluminum foil or a corrugated paper carton.

### BRIEF DESCRIPTION OF THE DRAWING

FIG. 1 shows a multi-layer lamination structure according to the present invention.

### BRIEF DESCRIPTION OF SYMBOLS OF THE DRAWING

| Symbol | Meaning |
|---|---|
| 1 | non-woven fabric |
| 2 | moisture-semipermeable film |
| 3 | 1-MCP-releasable laminate |
| 4 | moisture evaporating from agricultural |
| | products |

### DETAILED DESCRIPTION OF THE INVENTION

The present invention provides a non-woven fabric laminate comprising at least one layer of a thermoplastic composition, comprising an agent for blocking the ethylene binding site in plants, i.e., an ethylene-blocking agent, and a thermoplastic polymer or copolymer, and at least one layer of a non-woven fabric.

According to the present invention, the ethylene-blocking agent for blocking the ethylene binding site in plants includes all the conventional compounds that inhibit ethylene responses in plants, such as, but not limited to, cyclopropene, 1-methylcyclopropene, 3,3-dimethycyclopropene, methylenecyclopropane, diazocyclopentadiene, trans-cyclooctene, cis-cyclooctene, 2,5-norbornadiene, the derivatives thereof and the mixtures thereof. The relevant prior art, such as U.S. Pat. Nos. 3,879,188, 5,100,462, 5,518,988, and 6,017,849, and Sisler et al., Plant Growth Reg. 9, 157-164, 1990 are incorporated into the specification by reference in their entirety. Preferably, the agent for blocking the ethylene binding site in plants is 1-methylcyclopropene.

A number of thermoplastic polymers or copolymers are suitable to be used in the present invention, and include, but are not limited to, oxyalkanoyl polymers and dialkanoyl polymers, which are normally solid and are optionally blended with polyvinylalcohol or starch polymers that maybe film-formed, olefin-based polymers including the most common ethylene or propylene based polymers, such as polyethylene, polypropylene, and olefin-based copolymers, such as ethylene vinylacetate (EVA), ethylene methylacrylate (EMA) and ethylene acrylic acid (EAA), and copolymers of the above-mentioned polyolefins.

The thermoplastic composition, which can release ethylene-blocking agent of the invention, contains a thermoplastic polymer or copolymer and an ethylene-blocking agent such as commercial 1-MCP in any powdery form. The weight ratio of polymer or copolymer and ethylene-blocking agent is between 2000:1 to 1:1, preferably between 100:1 to 1:1, and more preferably between 20:1 to 1:1.

According to the present invention, the thermoplastic composition may further contain a filler used in conventionally tablet or powder form. Suitable fillers include, but are not limited to, antibacterial agents, polymeric absorbents, chitosan, dextrin, clay and montmorillonite.

The non-woven fabric used in the present invention may be any known and conventionally used by skilled artisans. Suitable non-woven fabrics include, but are not limited to, fibers of polyethylene, polypropylene, polyesters, rayon, cellulose and nylon, and blends of such fibers. As used herein, “non-woven fabric” is used in its generic sense to define a generally planner structure that is relatively flat, flexible and porous, and is composed of staple fibers or continuous filaments. The weight of the non-woven fabric adopted in the invention will depend on practical applications. Preferably, the weight of the non-woven fabrics of the invention is in the range of 20 to 300 g/m², and more preferably from 30 to 150 g/m².

The basic weight of the non-woven fabric laminate of the present invention depends upon the ethylene-blocking agent dosage required for treatment. In general, the basic weight of the layer of thermoplastic composition which can release ethylene-blocking agent applied to the non-woven fabric layer is approximately 7 to 50 g m², preferably approximately 10 to 35 g/m².

The major advantage of the novel non-woven fabric laminate of the present invention is that it is flexible and convenient for the application of the ethylene-blocking agent for blocking the ethylene binding site in plants. The novel non-woven fabric laminate alleviates the disadvantages of mixing associated with the powder form and the limitations of application associated with the tablet form.

The present invention further provides a method of making the novel non-woven fabric laminate of the subject invention, comprising bonding a layer of a thermoplastic composition, comprising an agent for blocking the ethylene binding site in plants and a thermoplastic polymer or copolymer, to a layer of a non-woven fabric.

Processes of bonding thermoplastic layers to a layer of non-woven fabric have been known for some time. Additionally, processes for bonding thermoplastic layers to non-woven fabrics by a hot melt adhesion laminating or an extrusion laminating are well known in the art. The application of these concepts to agricultural post-harvest preservation, however, has never been attempted before.

In more general sense of the invention, any method may be used for manufacturing the non-woven fabric laminate and there is no particular limitation to the method that the laminate can be formed into an integral form. For example, according to the present invention, the layer of the thermoplastic composition comprising a blend of the thermoplastic polymer or copolymer and the ethylene-blocking agent may be bonded to the layer of the non-woven fabric by a hot melt adhesion laminating or by an extrusion laminating.

The present invention further provides a method for inhibiting an ethylene response in a plant using the non-woven fabric laminate of the present invention. For example, the novel non-woven fabric laminate of the invention can be cut into a proper size for use as a cover sheet for fruits or vegetables stored within a container, or formed into a bag by joining together the edge. The moisture evaporating from agriculture products in such a container or bag will induce the release of the ethylene blocking agent in a gaseous form from the non-woven fabric laminate of the present invention.

According to the present invention, the non-woven fabric laminate can be extended to a multi-layer structure, comprising more than one layer of the thermoplastic composition which can release the ethylene-blocking agent and more than one layer of the non-woven fabric. The sequences and dispositions of layers within the multi-layer structure depend on practical uses. Preferably, layers of the thermoplastic composition, which can release the ethylene-blocking agent, and layers of the non-woven fabric are alternated in the multi-layer structure.

The non-woven fabric laminate of the present invention may have an additional moisture-semipermeable film, used to regulate the moisture released from the agricultural products. In this embodiment, the moisture-semipermeable film is placed at the outermost layer of the laminate facing stored agricultural products in practical utilization. Typical moisture-semipermeable films include, but are not limited to urethanes, polyamides, polyester, and nylon as well as blends of these hydrophilic polymers.

In another aspect of the invention, the concept of the non-woven fabric laminate can be applied to a laminate with aluminum foils, corrugated paper cartons, or other suitable substrate material, or any other combination thereof. A layer of an aluminum foil or a corrugated paper carton can be bonded to a layer of a thermoplastic composition, comprising an agent for blocking the ethylene binding site in plants and a thermoplastic polymer or copolymer by any method known in the art, such as a hot melt adhesion laminating or an extrusion laminating.

Accordingly, the present invention further provides an aluminum foil laminate for inhibiting an ethylene response in a plant, comprising at least one layer of a thermoplastic composition comprising an agent for blocking the ethylene binding site in plants and a thermoplastic polymer or copolymer, and at least one layer of an aluminum foil.

The present invention also provides a corrugated paper carton laminate for inhibiting an ethylene response in a plant, comprising at least one layer of a thermoplastic composition comprising an agent for blocking the ethylene binding site in plants and a thermoplastic polymer or copolymer, and at least one layer of a corrugated paper carton.

According to the present invention, the term “plant” is intended to include woody-stemmed plants in addition to field crops, potted plants, cut flowers, harvested fruits, vegetables and ornamentals.

Plants treated by the non-woven fabric laminate of the present invention inhibiting the ethylene response need to be treated with a non-phytotoxic amount. This phytotoxic level varies not only by plant but also by cultivar.

According to the present invention, numerous ethylene responses may be prevented, such as those disclosed in U.S. Pat. Nos. 5,518,988 and 3,879,188. Ethylene responses may be initiated by either exogenous or endogenous sources of ethylene. Ethylene responses include, for example, the ripening and/or senescence of flowers, fruits and vegetables; the abscission of foliage, flowers and fruit; the prolongation of the life of ornamentals, such as potted plants, cut flowers, shrubbery and dormant seedlings; the inhibition of growth in some plants such as the pea plant; and the stimulation of plant growth in some plants such as the rice plant.

According to the present invention, vegetables which may be treated to inhibit senescence include leafy green vegetables such as lettuce (e.g., Lactuea sativa), spinach (Spinaca oleracea) and cabbage (Brassica oleracea; various roots such as potatoes (Solanum tuberosum), carrots (Daucus); bulbs such as onions (Allium sp.); herbs such as basil (Ocimum basilicum), oregano (Origanum vulgare) and dill (Anethum graveolens); as well as soybean (Glycine max), lima beans (Phaseolus limensis), peas (Lathyrus sp.), corn (Zea mays), broccoli (Brassica oleracea italica), cauliflower (Brassica oleracea botrytis) and asparagus (Asparagus officinalis).

According to the present invention, fruits which may be treated to inhibit ripening include tomatoes (Lycopersicon esculentum), apples (Malus domestics), bananas (Musa sapientum), pears (Pyrus communis), papaya (Carica papya), mangoes (Mangifera indica), peaches (Prunus persica), apricots (Prunus armeniaca), nectarines (Prunus persica nectarina), oranges (Citrus sp.), lemons (Citrus limonia), limes (Citrus aurantifolia), grapefruit (Citrus paradisi), tangerines (Citrus nobilis deliciosa), kiwi (Actinidia Chinenus), melons such as cantaloupes (C. cantalupensis) and musk melons (C. melo), pineapples (Aranae comosus), persimmon (Diospyros sp.) and raspberries (e.g., Fragaria or Rubus ursinus), blueberries (Vaccinium sp.), green beans (Phaseolus vulgaris), members of the genus Cucumis such as cucumber (C. sativus) and avocados (Persea Americana).

According to the present invention, ornamental plants which may be treated to inhibit senescence and/or to prolong flower life and appearance (such as the delay of wilting) include potted ornamentals and cut flowers. Potted ornamentals and cut flowers which may be treated with the methods of the present invention include azalea (Rhododendron spp.), hydrangea (Macrophylla hydrangea), hibiscus (Hibiscus rosasanensis), snapdragons (Antirrhinum sp.), poinsettia (Euphorbia pulcherima), cactus (e.g., Cactaceae schlumbergera truncata), begonias (Begonia sp.), roses (Rosa sp.), tulips (Tulipa sp.), daffodils (Narcissus sp.), petunias (Petunia hybrida), carnation (Dianthus caryophyllus), lily (e.g., Lilium sp.), gladiolus (Gladiolus sp.), Alstroemeria (Alstroemaria brasiliensis), anemone (e.g., Anemone bland), columbine (Aquilegia sp.), aralia (e.g., Aralia chinesis), aster (e.g., Aster carolinianus), bougainvillea (Bougainvillea sp.), camellia (Camellia sp.), bellflower (Campanula sp.), cockscomb (Celosia sp.), falsecypress (Chamaecyparis sp.), chrysanthemum (Chrysanthemum sp.), clematis (Clematis sp.), cyclamen (Cyclamen sp.), freesia (e.g., Freesia refracta), and orchids of the family Orchidaceae.

According to the present invention, plants which may be treated to inhibit abscission of foliage, flowers and fruits include cotton (Gossypium spp.), apples, pears, cherries (Prunus avium), pecans (Carva illinoensis), grapes (Vitis vinifera), olives (e.g., Olea europaea), coffee (Coffea arabica), snapbeans (Phaseolus vulgaris), and weeping fig (Ficus benjamina), as well as dormant seedlings such as various fruit trees including apple, ornamental plants, shrubbery, and tree seedlings.

In addition, according to the present invention, shrubbery which may be treated to inhibit abscission of foliage include privet (Ligustrum sp.), photinea (photina sp.), holly (Ilex sp.), ferns of the family polypodiaceae, schefflera (Schefflera sp.), aglaonema (Aglaonema sp.), cotoneaster (Cotoneaster sp.), barberry (Berberris sp.), waxmyrtle (Myrica sp.), abelia (Abelia sp.), acacia (Acacia sp.), and bromeliades of the family Bromeliaceae.

Without further elaboration, it is believed that one skilled in the art can, based on the above disclosure and the examples described below, utilize the present invention to its fullest extent. The following examples are to be construed as merely illustrative examples of how one skilled in the art can practice the claimed methods and are not limitative of the remainder of the disclosure in any way.

### EXAMPLE 1

### Method of Making

A blend of ethylene vinyl acetate (EVA) and a 1-methylcyclopropene powder having the following composition was laminated to a non-woven fabric.

57% ethylene vinyl acetate

38% 1-methylcyclopropene powder (Ansip® from Lytone Enterprise, Inc. Taipei, Taiwan, ROC)

5% sodium polyacrylate (one of a polymeric absorbent)

One non-woven fabric (polyethylene+rayon) of 50 g/m² was laminated by heat melt adhesion by above 1-MCP-releasable composition employing the heat melt laminator. A scattering unit over the working area of the non-woven fabric applied the thermoplastic coating material powder onto the fabric. The amount of powder added to each unit surface area can be determined by the rotation speed of dosing roller. In this example, 12 g/m² of 1-MCP-releasable material as described was laminated on the non-woven fabric.

### EXAMPLE 2

### 1-MCP Release form Non-Woven Fabric Laminate

The 1-MCP release characteristics of the 1-MCP-releasable non-woven fabric laminate was determined by placing a dimension 10×10 cm laminate into a chamber, spraying water on the surface of laminate, and analyzing the 1-MCP concentration by Gas Chromatography (GC).

Table 1 shows the release profile of 1-MCP from the non-woven fabric laminate. It is clear that applying water on the surface of such 1-MCP-releasable laminate can readily induce the release of 1-MCP easily. Even at the initial time the laminate had already released 5% of 1-MCP, moreover, 70% of active ingredient had been released at 5 min.

TABLE 1

| Time | 1-MCP released |
|---|---|
| (min) | from non-woven sheet (%) |
| 0 | 5 |
| 5 | 70 |
| 20 | 85 |
| 40 | 91 |
| 60 | 100 |

### EXAMPLE 3

### Application

Banana fruits were harvested at 80% ripeness for evaluation of the performance of the 1-MCP-releasable non-woven fabric laminate described in the present invention. The laminate was cut to a dimension of 20×20 cm as cover sheet for fruits.

Three replicates of fruit cluster, containing four to five fingers per cluster, were used for treatment in the experiment. Each treatment was stored in a 36 liter volume close container (relative humidity: 90-95%) for 24 h at room temperature, and then removed for quality observation.

The results show the treatment with 1-MCP-releasable cover sheet can prolong the shelf life to 14-17 days, longer than the control of 7-9 days.

### EXAMPLE 4

### Multi-Layer Lamination

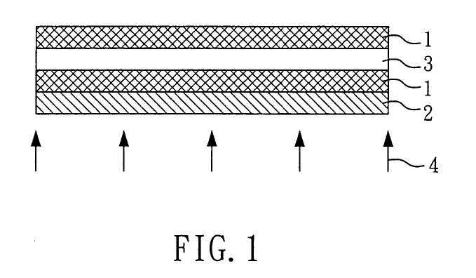

A multi-layer lamination structure according to FIG. 1 is composed of a non-woven fabric 1, a moisture-semipermeable film 2, and a 1-MCP-releasable laminate 3 as described in the present invention. The non-woven fabric 1 and 1-MCP-releasable laminate 3 are made according the Example 1. The moisture-semipermeable film 2 made from urethane (10 g/m²) is coated at the outermost layer for regulating moisture evaporating from agricultural products 4.

Bonding all materials together is performed by using an air-permitting drum. The temperature of the air is 170° C.

1. A non-woven fabric laminate for inhibiting an ethylene response in a plant, comprising at least one layer of a thermoplastic composition comprising an agent for blocking an ethylene binding site in plants and a thermoplastic polymer or copolymer, and at least one layer of a non-woven fabric.

2. The laminate of claim 1, wherein the agent for blocking the ethylene binding site in plants is selected from the group consisting of cyclopropene, 1-methylcyclopropene, 3,3-dimethycyclopropene, methylenecyclopropane, diazocyclopentadiene, trans-cyclooctene, cis-cyclooctene, 2,5-norbornadiene, the derivatives thereof, and the mixtures thereof.

3. The laminate of claim 2, wherein the agent for blocking the ethylene binding site in plants is 1-methylcyclopropene.

4. The laminate of claim 1, wherein the thermoplastic polymer is selected from the group consisting of oxyalkanoyl polymers and dialkanoyl polymers, optionally blended with polyvinylalcohol or starch polymers, and olefin-based polymers.

5. The laminate of claim 4, wherein the olefin-based polymer is ethylene or propylene based polymers.

6. The laminate of claim 5, wherein the olefin-based polymer is polyethylene or polypropylene.

7. The laminate of claim 1, wherein the thermoplastic copolymer is selected from the group consisting of ethylene vinylacetate (EVA), ethylene methylacrylate (EMA), ethylene acrylic acid (EAA), and copolymers of polyolefins.

8. The laminate of claim 1, wherein the weight ratio of the thermoplastic polymer or copolymer and the agent for blocking the ethylene binding site in plants is between 2000:1 to 1:1.

9. The laminate of claim 8, wherein the weight ratio of the thermoplastic polymer or copolymer and the agent for blocking the ethylene binding site in plants is between 100:1 to 1:1.

10. The laminate of claim 9, wherein the weight ratio of the thermoplastic polymer or copolymer and the agent for blocking the ethylene binding site in plants is between 20:1 to 1:1.

11. The laminate of claim 1, wherein the thermoplastic composition further contains a filler selected from the group consisting of antibacterial agents, polymeric absorbents, chitosan, dextrin, clay and montmorillonite.

12. The laminate of claim 1, wherein the non-woven fabric comprises fibers selected from the group consisting of polyethylene, polypropylene, polyesters, rayon, cellulose, nylon, and blends thereof.

13. The laminate of claim 12, wherein the non-woven fabric is composed of staple fibers.

14. The laminate of claim 12, wherein the non-woven fabric is composed of continuous filaments.

15. The laminate of claim 1, wherein the basic weight of the layer of thermoplastic composition applied to the layer of non-woven fabric is 7 to 50 g/m².

16. The laminate of claim 15, wherein the basic weight of the layer of thermoplastic composition applied to the layer of non-woven fabric is 10 to 35 g/m².

17. The laminate of claim 1, wherein the basic weight of the layer of non-woven fabric is 20 to 300 g/m².

18. The laminate of claim 17, wherein the basic weight of the layer of non-woven fabric is 30 to 150 g/m².

19. The laminate of claim 1, wherein the agent for blocking the ethylene binding site in plants is released in a gaseous form.

20. The laminate of claim 1, which is a multi-layer structure wherein layers of the thermoplastic composition which can release the ethylene-blocking agent and layers of the non-woven fabric are alternated in the multi-layer structure.

21. The laminate of claim 1, further comprising a moisture-semipermeable film placed at the outermost layer of the laminate.

22. The laminate of claim 21, wherein the moisture-semipermeable film is selected from the group consisting of urethanes, polyamides, polyesters, nylon and blends thereof.

23. A method of making a non-woven fabric laminate for inhibiting an ethylene response in a plant, comprising bonding a layer of a thermoplastic composition, comprising an agent for blocking an ethylene binding site in plants and a thermoplastic polymer, to a layer of a non-woven fabric.

24. The method of claim 23, wherein the layer of the thermoplastic composition is bonded to the layer of the non-woven fabric by a hot melt adhesion laminating.

25. The method of claim 23, wherein the layer of the thermoplastic composition is bonded to the layer of the non-woven fabric by an extrusion laminating.

26. A method for inhibiting an ethylene response in a plant, comprising using the non-woven fabric laminate of claim 1.

27. An aluminum foil laminate for inhibiting an ethylene response in a plant, comprising at least one layer of a thermoplastic composition comprising an agent for blocking the ethylene binding site in plants and a thermoplastic polymer or copolymer, and at least one layer of an aluminum foil.

28. A corrugated paper carton laminate for inhibiting an ethylene response in a plant, comprising at least one layer of a thermoplastic composition comprising an agent for blocking the ethylene binding site in plants and a thermoplastic polymer or copolymer, and at least one layer of a corrugated paper carton.
